(19) United States
(12) Patent Application Publication
(10) Pub. No.: US 2008/0260496 A1
(43) Pub. Date: Oct. 23, 2008

(54) Fastener With Visual Indicator

(76) Inventor: Jason B. Parmann, Oconomowoc, WI (US)

Correspondence Address: BOYLE FREDRICKSON S.C., 840 North Plankinton Avenue, MILWAUKEE, WI, 53203, US

(21) Appl. No.: 12/104,892

(22) Filed: Apr. 17, 2008

Related U.S. Application Data
(60) Provisional application No. 60/912,322, filed on Apr. 17, 2007.

(51) Int. Cl. F16B 15/00

(52) U.S. Cl. 411/439

(57) ABSTRACT

A fastener that includes a head portion and a body and is configured to be driven into material. The body is configured for engaging the material and the head portion is constructed to be engaged by a driver of a power nailer. A color coating is applied to a face of the head portion for visually locating fasteners engaged with the material

### CROSS-REFERENCE TO RELATED APPLICATION

This application claims priority to provisional application U.S. Ser. No. 60/912,322 filed on Apr. 17, 2007 and titled “FASTENER WITH VISUAL INDICATOR.”

### BACKGROUND

This invention relates to mechanical fasteners, and more particularly, to nails constructed to be driven by nail guns. Various construction tasks require securing one member to another. Any of a number of common fasteners can be used to secure together adjacent members. In the construction trades, these fasteners are frequently provided as either of screws or nails. In planned structure construction, the interface between various elements of the structure, such as a stud wall, sill plates, top plates, headers, hangers, sheathing, etc., are generally specified by various building codes or other structural standards. To provide some surety as to the integrity and the quality of the structure, many municipalities require structures be periodically inspected or checked to confirm that the structure at least satisfies the requirements of the code.

During a routine inspection, an inspector generally visually confirms that the elements of the structure are secured together in accordance with customary building practices. The inspection generally includes visually confirming that an appropriate number of fasteners or fastener spacing has been adhered to during the assembly of the structure. Frequently, the trades person or inspector must visually confirm that the placement and spacing of fasteners satisfies certain building code requirements. The structure being inspected, the time of day, and the ambient conditions each affect a person's ability to visually confirm fastener positioning.

Unfortunately, the construction of many common fasteners, the orientation of the fasteners, and the material being fastened affect the ability to quickly and easily identify fastener positioning and spacing. The identification of many common fasteners is made only more difficult because of the relatively small appearance of the common fasteners with respect to the scale of the structure. Shadow lines and/or bright working conditions also detrimentally affect the ability to readily discern between fastener and material. The inability to readily assess fastener placement and distribution prolongs inspection durations, can result in the inadvertent objections to construction practices, and can agitate both inspectors and tradesmen. Accordingly, it is desired to provide a system wherein fastener placement, type, and distribution can be quickly and easily ascertained.

Understandably, another consideration of fastener installation is relation of the fastener with installation tools. Commonly, nails are placed with pneumatic or electric nailers or drivers. A number of the fasteners are often connected via a collation and oriented to cooperate with a feed or sleeve of the installation tool. The collation can be provided as any of a wire, a paper, or a plastic strip that connects a number of fasteners in a row, stick, or string.

Powered nailers commonly include a driver that impacts a portion of a head of single nail and both severs the collation and drives the single nail into place. These driving tools greatly increase the number of fasteners a single laborer can place as compared to hand driven or placed fasteners. Accordingly, it is also desired to that the system also cooperate with powered tools common to the trades.

### SUMMARY OF THE INVENTION

The present invention is directed to a fastener system that addresses one or more of the above problems. According to one aspect, the invention includes a fastener that has a body for engaging a material and a head portion. The head portion is constructed to be engaged by a driver of a power nailer. A color coating is applied to a face of the head portion such that the fastener can be visually located when it is engaged with a material.

Another aspect of the invention consistent with the above aspect includes a group of fasteners that include a first nail and a second nail. The second nail is attached to the first nail for being fed through a nailer. At least one of the first and second nails includes a visual indicator that is applied to a head of the nail.

A further aspect of the invention useable with one or more of the above aspects includes a method of providing a fastener that includes providing a number of nails. The number of nails are collated for passage through an automatic nailer. An impact resistant coating is applied to a head portion of each nail such that the coating is visible and provides an indication of an in use position of a nail.

A further aspect of the invention useable with one or more of the above aspects includes providing the visual indication as a fluorescent color coating. Preferably each faster is provided as one of a number of fasteners that are collated together. Preferably, the collation is formed by one a metal, a paper, or a plastic material. Another aspect of the invention useable with one or more of the above aspects includes providing a number of types of fasteners wherein each type of fastener includes an indication specific to the type of fastener. Examples of such types of fasteners include six, eight, ten, twelve, or sixteen penny nails or fasteners that form a staple, i.e. a two legged fastener. Understandably, the fasteners could be any of smooth shanked or ring shanked. The fasteners can also be provided in either of a stick or a coil configuration. Preferably, the fasteners are configured to be fed automatically through a magazine or feed of a nailer.

Various other features, aspects, and advantages of the present invention will be made apparent from the following detailed description and the drawings.

### BRIEF DESCRIPTION OF THE DRAWINGS

The drawings illustrate one preferred embodiment presently contemplated for carrying out the invention and in the drawings:

FIG. 1 is an elevational view of a structure having building members that are secured to one another with a number of nails according to the present invention;

FIG. 2 is a perspective view of a nailer for placing the nails shown in FIG. 1;

FIG. 3 is an elevational view of a set or stick of collated nails that are oriented to feed through the nailer shown in FIG. 2;

FIG. 4 is a detailed view of the collated nails taken along line 4-4 shown in FIG. 3; and

FIG. 5 is an elevational view of the collated nails taken along line 5-5 shown in FIG. 4.

### DETAILED DESCRIPTION OF THE PREFERRED EMBODIMENT

FIG. 1 shows a number of fasteners or nails 10 constructed according to the present invention. As shown in FIG. 1, nails 10 secure a first material or structure, such as sheathing 12 to a second material or structure, or a stud wall 14. It is appreciated that nails 10 can be used to connect a variety of construction materials where it is desired to be able to reaasily inspect the placement of the fasteners. It is appreciated that other structures, such as rough framing, hangers, sill plates, top plates, and headers may be secured with fasteners constructed according to the present invention. It is further appreciated that although structures 12, 14 are shown as what is commonly understood as orientated strand board (OSB) and dimensional lumber, nails 10 can be used to secure various types, shapes, and sizes of materials including, foam materials, cementations products, wall board, plastic materials, etc. It is also appreciated that nails according to the present invention could be any common fastener including what is commonly referred to as 16, 12, 10, 8, or 6 penny nails, roofing nails, shingle nails, joist hanger nails, staples, etc. It is further appreciated that nails 10 could also have a plain or a ring shank construction. It is envisioned that the present invention is applicable to any automatically driven fastener where visual inspection of a head of the driven fastener is desired.

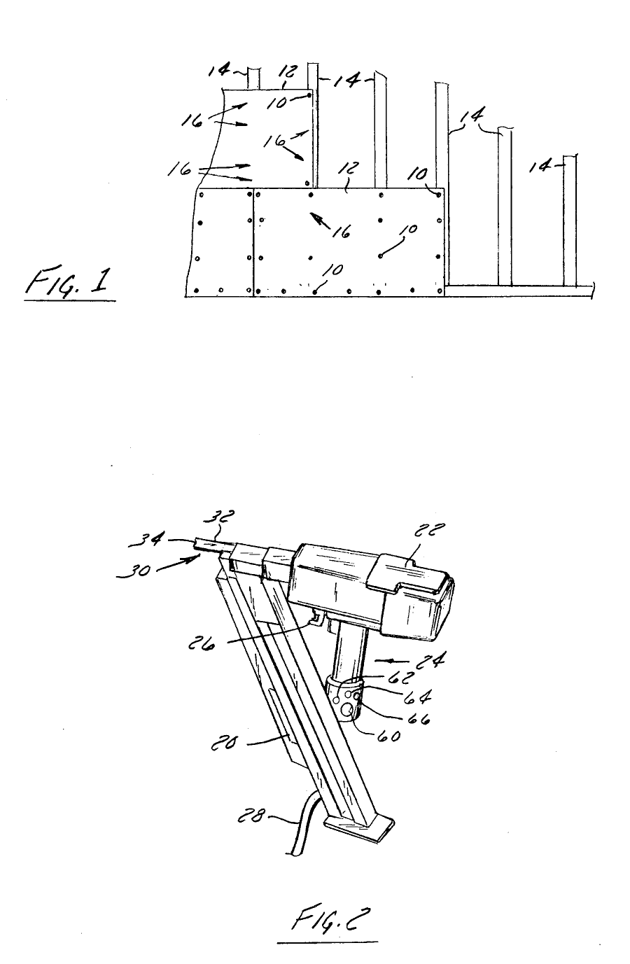

As shown in FIG. 1, nails 10 are readily identifiable when positioned to secure first structure 12 to second structure 14. Also important, nails 10 further indicate areas where a fastener has been omitted, indicated by arrows 16. Omitted fastener areas 16 can be readily identified, and therefore quickly corrected, by the visual inspection of nails 10. Referring to FIGS. 2 and 3, nails 10 are collated into a group of fasteners or a stick 18 constructed to operatively engage a feed, slide, or magazine 20 of an automatic nail gun or nailer 22. Nailer 22 includes a grip 24 in the trigger 26 positioned proximate grip 24. An air source, indicated by an air hose 28, communicates a driving source and nailer 22. Alternatively, nailer 22 could be electrically powered or completely wireless such as battery or gas container powered. A tip portion 30 of nailer 22 includes an actuator 32 constructed to operationally engage structure 12. Actuator 32 is activated when tip portion 30 is pressed against structure 12. A driver 34 is axially supported within nailer 22 and constructed to translate upon actuation of actuator 32 and pressing of trigger 26. Depressing trigger 26 when actuator 32 is activated directs driver 34 into engagement with a respective nail 10 of stick 18 positioned in magazine 20. Understandably, the construction and operation of nailer 22 is merely exemplary of a nailer usable with the present invention. The present invention is applicable with nailers having other features and other operating constructions. Such features can include alternative feed systems, such as coiled feeds, and other operating tips or accessories that effect the operation of nailer 22.

Referring to FIGS. 2 and 3, driver 34 is constructed to impact a head portion 36 of a respective nail 10 of stick 18. The impact of driver 34 with head portion 36 severs a collating structure 38 of stick 18. Collating structure 38 is shown as a pair of wires that are connected to each nail 10 of stick 18. Other collating structures, such as paper or plastic materials or more or fewer wire strands, are envisioned and within the scope of the claims. It is further appreciated that rather than being provided in stick form, the collection of collated fasteners could be provided in coil form or another shape associated with a given nail gun. The collating material as well as the shape of the collection of collated fasteners could be any of a number of envisioned materials and configurations. Commonly, the collation of fasteners is associated with a given tool specific to placing one or more of a given type of fasteners.

Many nailers are constructed to receive various types of fasteners. One such nailer is operable with 8 penny and 16 penny nails as well as joist hanger nails. Generally, the collation material and an inclination angle are the same for each type of nail such that the nails sequentially feed through the feed mechanism of the nailer regardless of the type of nail being placed.

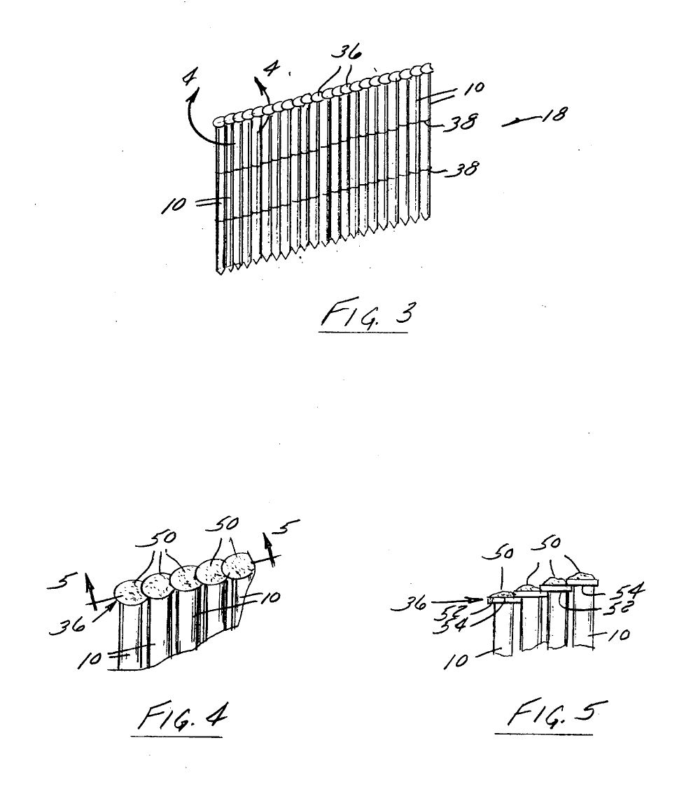

Referring to FIGS. 4 and 5, each head portion 36 of each respective nail 10 includes a visual indicator 50 secured to a face 52 of each head portion 36. Each visual indicator 50 is constructed to withstand the impact of driver 34 and is constructed such that the segregation of an individual nail 10 from stick 18 does not interfere with the visual indicator 50 of subsequent nails 10. Such a construction ensures that the visual indicator remains engaged with the underlying nail 10 during driving of the nail 10 with nail gun 22. Such a construction also ensures that the visual indicator does not detract from the performance of nailer 22 or interfere with the user's performance during use.

Preferably, visual indicator 50 exhibits fluorescent, neon, or reflective properties to enhance the ability to detect nails 10 when secured in structures 12, 14. More preferably, visual indicator 50 is a layer of paint of a color that can be readily seen in a number of light and weather conditions and that remains attached to head portion 36 of nails 10 through the driving process. It is further appreciated that, although an interface 54 between visual indicator 50 and face 52 is shown as generally planar, other configurations, such as forming one of more recesses in face 52 are envisioned and within the scope of the claims. It is further envisioned that visual indicator 50 could be formed during a manufacturing process, such as an upsetting process during formation of head portion 36 such that visual indicator 50 would be integrated into the material of nail 10. Each of these alternatives is within the scope of the invention and presents a fastener whose construction is lacking in art.

It is further envisioned that each visual indicator 50 be associated with a given type of nail 10. For example, 8 penny and 16 penny nails could each be provided with a visual indicator that is specific to the type of nail such that the type of fastener can be identified simply by inspection of the visual indicator. Additionally, referring to FIGS. 2 and 4, it is envisioned that nailer 22 include a selector 60 that is configured to correspond to an indicia 62, 64, 66. Preferably, each indicia 62, 64, 66 is associated with a specific type of fastener. For example, each indicia 62, 64, 66 could be associated with a size of a fastener, a composition of the material being worked, etc. Preferably, indicia 62, 64, 66 correlate to different visual indicators 50 and to an operating condition of nailer 22 that is common to the type of nail associated with each given visual indicator 50. For example, if 8 penny nails are pink and 16 penny nails are neon green, when an operator loads a type of nail into feed 20, pointing indexing selector 60 to the corresponding colored indicia 62, 64, 66, configures nailer 22 for operation with the fastener associated with the particular visual indictor such as by altering the air pressure communicated through the nailer or altering the stroke of driver 34. Such a configuration prevents inadvertent incidents of overdriving nails of any given type. Such a configuration also simplifies the user's interaction with nailer 22 and provides proper setting of the operation of nailer 22 with respect to any given fastener.

It can thus be appreciated that the present invention provides a fastener that can be quickly installed through utilization of powered nailers and that includes a visual indicator that can readily identified when the fastener is installed. It is further appreciated that the visual indicator is constructed and connected to the fastener to withstand the impact of the driver of the nailer. As one skilled in the art will fully appreciate, the heretofore description of fasteners and pneumatic tools has applications beyond the disclosed building structure application. It is appreciated that the present invention is equivalently applicable with any system that requires visual inspection of fasteners after the fasteners have been placed. The heretofore description of a nailer system illustrates just one embodiment in which the present invention may be implemented. The present invention has been described in terms of the preferred embodiment, and it is recognized that equivalents, alternatives, and modifications, aside from those expressly stated, are possible and within the scope of the appending claims.

I claim:

1. A fastener comprising:
a body for engaging a material;
a head portion constructed to be engaged by a driver of a power nailer; and
a color coating applied to a face of the head portion for visually locating fasteners engaged with the material.

2. The fastener of claim 1 wherein the color coating is fluorescent.

3. The fastener of claim 1 wherein the color coating is selected to withstand an impact with the driver.

4. The fastener of claim 1 further comprising a connector extending from the fastener and configured to secure additional fasteners to the fastener.

5. The fastener of claim 4 wherein the connector is constructed to be severed during operation of the driver.

6. The fastener of claim 5 wherein the connector is one of metal, plastic, and paper.

7. The fastener of claim 1 wherein the fastener is further defined as one of an eight penny nail, a sixteen penny nail, or a staple.

8. The fastener of claim 1 wherein the body of the fastener is one of smooth or ring shanked.

9. A group of fasteners comprising:
a first nail;
a second nail attached to the first nail for being fed through a nailer; and
a visual indicator applied to a head of at least one of the first and second nail.

10. The group of fasteners of claim 9 wherein the first and second nails are attached with at least one of a paper material, a plastic material, and a metal material.

11. The group of fasteners of claim 10 oriented in one of a stick configuration and a coil configuration.

12. The group of fasteners of claim 10 configured to be fed automatically through a magazine of the nailer.

13. The group of fasteners of claim 9 wherein the visual indicator is selected from a group of colors.

14. The group of fasteners of claim 13 wherein the group of colors includes colors that contrast with a color of a material to be fastened.

15. The group of fasteners of claim 14 wherein the group of fasteners is one of number of eight penny nails or sixteen penny nails and wherein a visual indicator of the eight penny nails is different than a visual indicator of the sixteen penny nails.

16. A method of providing a fastener comprising:
providing a number of nails;
collating the number of nails for passage through an automatic nailer; and
applying an impact resistant coating to a head portion of each nail such that the coating is visible and provides an indication of an in use position of a nail.

17. The method of claim 16 further comprising providing a number of types of nails.

18. The method of claim 17 further comprising applying different color of coatings to each of the number of types of nails such that each type of nails can be visually discerned.

19. The method of claim 18 further comprising associating each of the different colors with an installation setting on a pneumatic nailer.

20. The method of claim 16 wherein the collation is one of wire, paper, or plastic.
